(19) United States
(12) Patent Application Publication
(10) Pub. No.: US 2007/0204886 A1
(43) Pub. Date: Sep. 6, 2007

(54) Lift/immersion bath

(76) Inventor: Robert Sporer, Zaulsdorf (DE)

Correspondence Address: PYLE & PIONTEK LLC, 221 N. LASALLE STREET, SUITE 2036, CHICAGO, IL, 60601, US

(21) Appl. No.: 11/701,838

(22) Filed: Feb. 2, 2007

(30) Foreign Application Priority Data
Mar. 2, 2006 (DE) 10 2006 005 018.5

(51) Int. Cl. B08B 3/00; B08B 3/12

(52) U.S. Cl. 134/109; 134/135; 134/184

(57) ABSTRACT

The lift/immersion system for treating, particularly cleaning, workpieces, comprises a housing into which a treatment liquid, particularly a cleaning liquid, can be filled which forms an immersion bath in the housing, further comprising a lift device and a lift table connected thereto and provided with passage openings, on which the workpieces can be placed, and which during the treatment process is movable upwards and downwards through the immersion bath. The lift/immersion bath is characterized in that under the lift table a baffle plate is attached which during the treatment process is moved upwards and downwards in a section of the immersion bath with a small lateral play, so that treatment liquid is displaced during the downward movement and directed onto the workpieces with formation of turbulences in the immersion bath. This considerably intensifies the action of the immersion bath on the articles.

The present invention relates to a lift/immersion system for treating, particularly cleaning, workpieces, the system comprising a housing into which a treatment liquid, particularly a cleaning liquid, can be filled which forms an immersion bath in the lower portion of the housing, further comprising a lift device and a lift table connected thereto and provided with passage openings, on which the workpieces can be placed, and which during the treatment process is movable upwards and downwards in the immersion bath.

With such a system it is not only possible to clean and degrease workpieces, but also for example to de-coat, preserve or phosphate the same, for which purpose the respectively appropriate treatment liquid is used.

The workpieces to be treated are here first placed on the lift table arranged in the housing, the lift table being lowered after the lid of the housing has been closed, whereupon the treatment process starts. The lift table is here continuously moved upwards and downwards in the immersion bath positioned inside the housing, thereby generating a movement of the liquid by which the workpieces are cleaned on all sides.

The systems of that type that have so far been known are of a complicated construction and require a long treatment period to achieve a satisfactory cleaning effect.

It is the object of the present invention to provide a lift/immersion system of the type under consideration which while being of a simple construction achieves a considerably improved treatment effect.

This object is achieved according to the invention by the features of patent claim 1.

Advantageous developments of the invention are characterized in the subclaims.

According to the invention a baffle plate is attached under the lift table, which plate during the treatment process is moved upwards and downwards in a trough-like bottom section of the immersion bath with a small lateral play relative to the walls thereof, so that treatment liquid is displaced during the downward movement and directed at a high pressure through the immersion bath towards the lift table and the workpieces arranged on said table. In this process the liquid displaced under the baffle plate and directed towards the lift table generates strong turbulences in the immersion bath, so that the effect of the immersion bath on the articles is considerably intensified. At about 60 lifts/min and a lift path of preferably 50 to 100 mm, the effect created by these turbulences is increased by about 100%.

The bottom section of the immersion bath is preferably formed by a recess on the bottom of the housing, a surrounding gap remaining between the walls of said recess and the edge of the baffle plate.

The liquid displaced by the downward movement of the lift table and thus of the baffle plate can be directed in different ways and directions onto the workpieces, which may be provided either individually or in combination with one another. According to a first aspect of the invention the baffle plate comprises passage openings for the treatment liquid, which openings may have the shape of small slits and/or holes. When the baffle plate in the trough-like recess is pressed downwards, vigorous liquid jets will pass upwards through the openings of the baffle plate, the jets generating turbulences by reason of the preferably grid-like lift table and impinging with strong currents on the articles, which are thereby efficiently cleaned or otherwise treated by the liquid. In the subsequent upward movement of the lift table and the baffle plate, treatment liquid will again flow back under the baffle plate. To this end valve flaps are preferably provided on the baffle plate, the valve flaps being closed during the downward movement and opened during the upward movement.

It goes without saying that the baffle plate must show enough stiffness to be able to displace the treatment liquid in an efficient manner. In this instance the baffle plate may here be bent on the edges at a flat angle to withstand the pressure of the liquid in a better way.

According to a further aspect of the invention it is suggested that an upright, preferably vertical, flow channel communicates with the trough-like recess in the lower part of the immersion bath, the flow channel extending up to and beyond the upper position of the lift table (during the treatment process) and having lateral exit openings from which liquid that has been displaced out of the recess into the flow channel is directed through the immersion bath towards workpieces. Hence, these water jets generate flows and turbulences which act from the side and from above on the workpieces and also contribute to an intense cleaning action.

In this development of the invention, the baffle plate may have the above-mentioned passage openings which on the whole must be given smaller dimensions, so that an adequate amount of treatment liquid is additionally displaced into the flow channel, so that vigorous water jets are directed onto the lift table from both the bottom and the side and/or top. However, it may also be provided that the baffle plate has a closed surface, so that the water jets during the downward movement of the lift table will only exit from the lateral flow channel.

In the side wall of the flow channel, passage openings are provided for the exit of the liquid, and said passage openings may here also have the shape of small slits and/or holes.

It is within the scope of the present invention to provide two separate flow channels which, taken together, extend substantially over the whole width of the housing, so that all articles arranged on the lift table can be covered by the turbulences generated by the exiting liquid jets.

According to a further proposal of the invention the lift device of the lift table is formed by a single lift cylinder which in a preferred embodiment is a pneumatic cylinder. The lift cylinder is advantageously arranged near the rear wall of the housing in the center thereof and drivingly connected to a slide guide that has the lift table attached to it. The rear wall of the housing has hinged thereto the collapsible lid of the housing.

With great advantage it is provided that the lid is opened by the lift cylinder when the lift table is moved fully upwards for removing the workpieces treated. In this process the slide guide, which is connected to the lift cylinder, impinges on the lid, thereby pivoting the lid into the open position. As a result, the whole system just needs one single cylinder, whereby it is given a particularly simple construction. The downwardly directed lift movement simultaneously accomplishes the closing of the pivotable lid by gravity.

Since no electrical connection is required in this embodiment, the system is also best suited for the use of combustible and explosion-prone treatment liquids, such as cleaner's solvent.

It is however Within the scope of the invention that aqueous lye, for instance, may also be used as treatment liquid which can e.g. be heated via electric cartridge heaters.

According to a further proposal of the invention the system also comprises a device for discharging oils, greases and dirt particles deposited on the surface of the treatment bath. To this end a nozzle system may be arranged in the tank for creating a surface movement, whereby the floating oils and greases are discharged into a laterally flange-mounted stilling pool. The oil/water mixture may also be separated by a suitable oil separator.

In this embodiment of the invention the workpieces will remain after the treatment process in the immersion bath on the lift table for such a long time until the oils, etc. deposited on the liquid surface have been discharged, whereupon the lift table is lifted into the loading and unloading plane.

Further details of the invention become apparent from the following description of a few preferred embodiments and with reference to the drawings, of which:

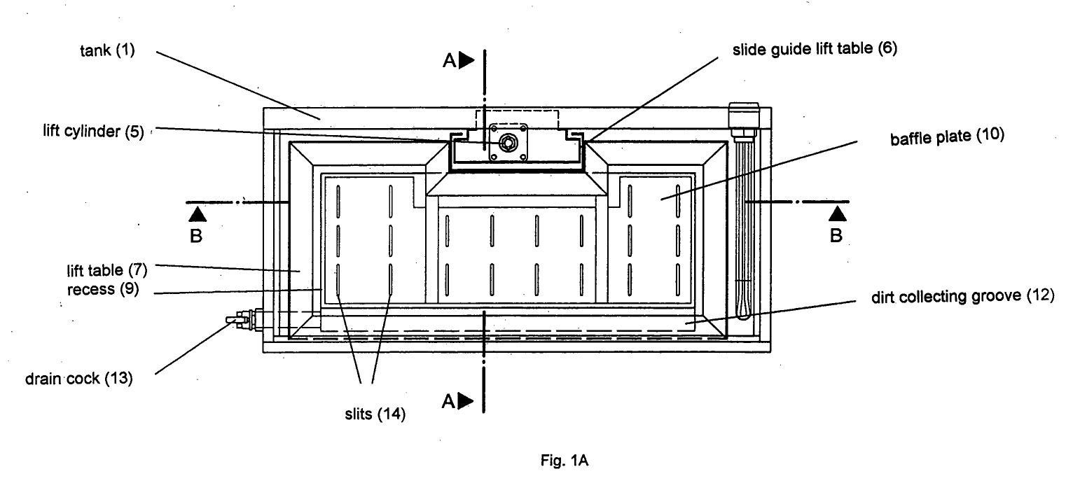

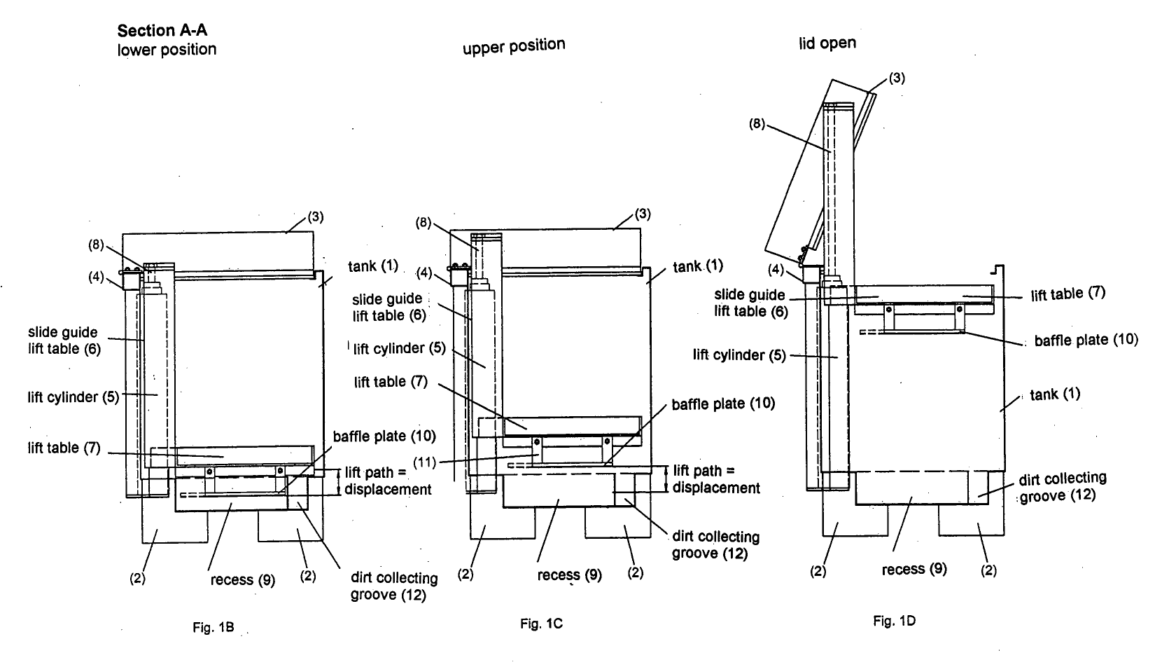

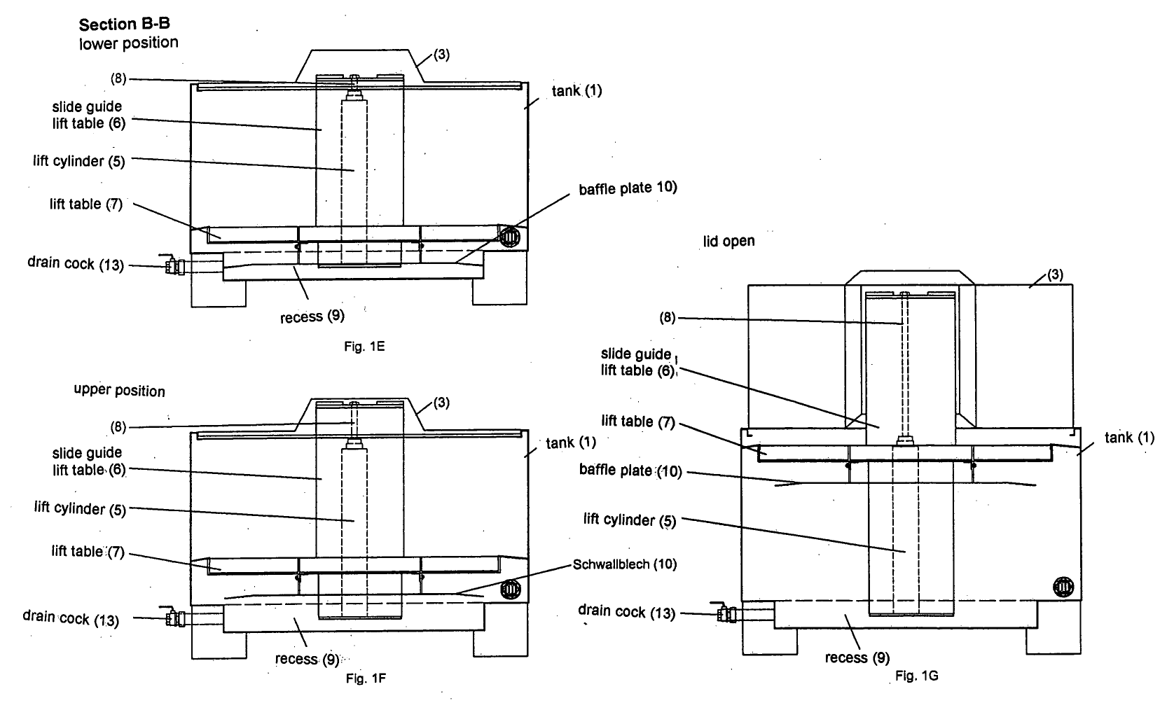

FIG. 1A shows a first embodiment of the lift/immersion system in a schematic top view;

FIGS. 1B to 1D show the lift/immersion system in schematic side views in the lower position of the lift table, the upper position of the lift table in the treatment process and in the loading and unloading position of the lift table;

FIGS. 1E to 1G show corresponding schematic illustrations of the embodiment from the front;

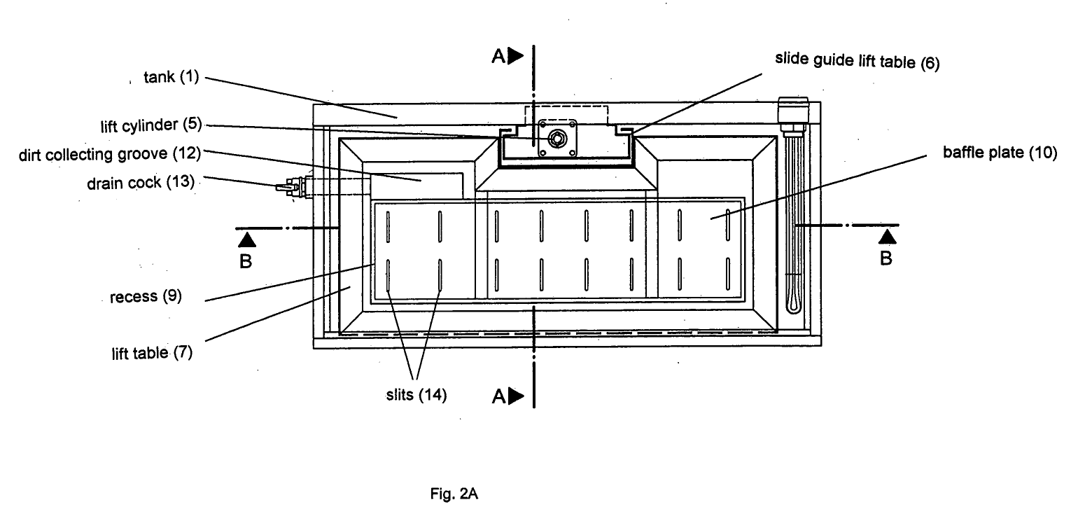

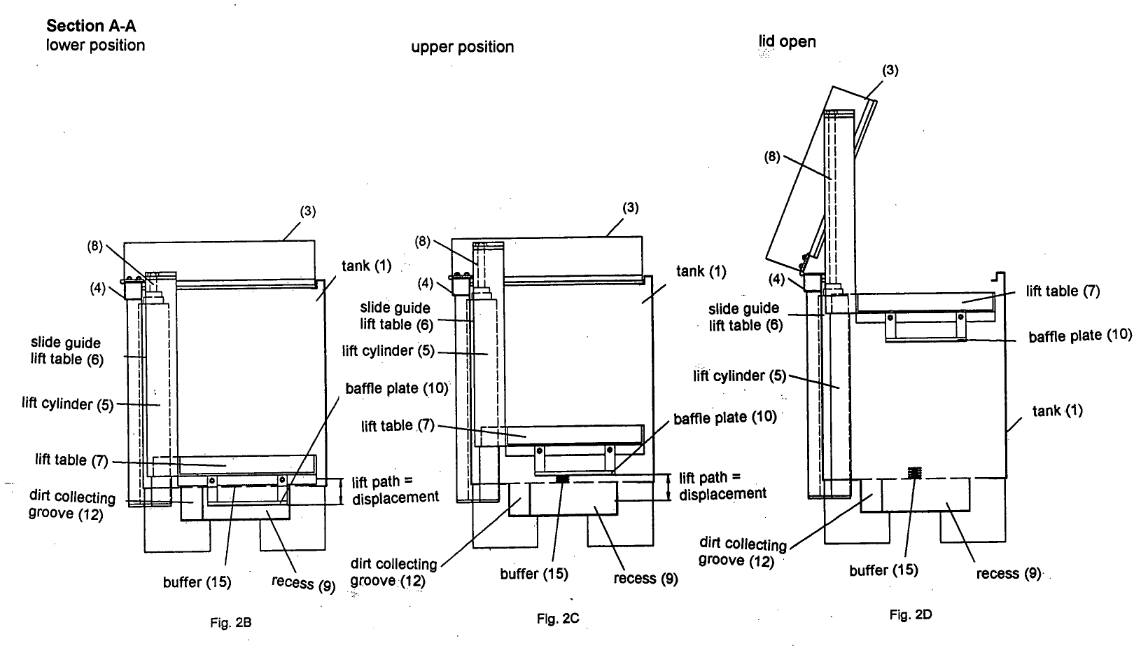

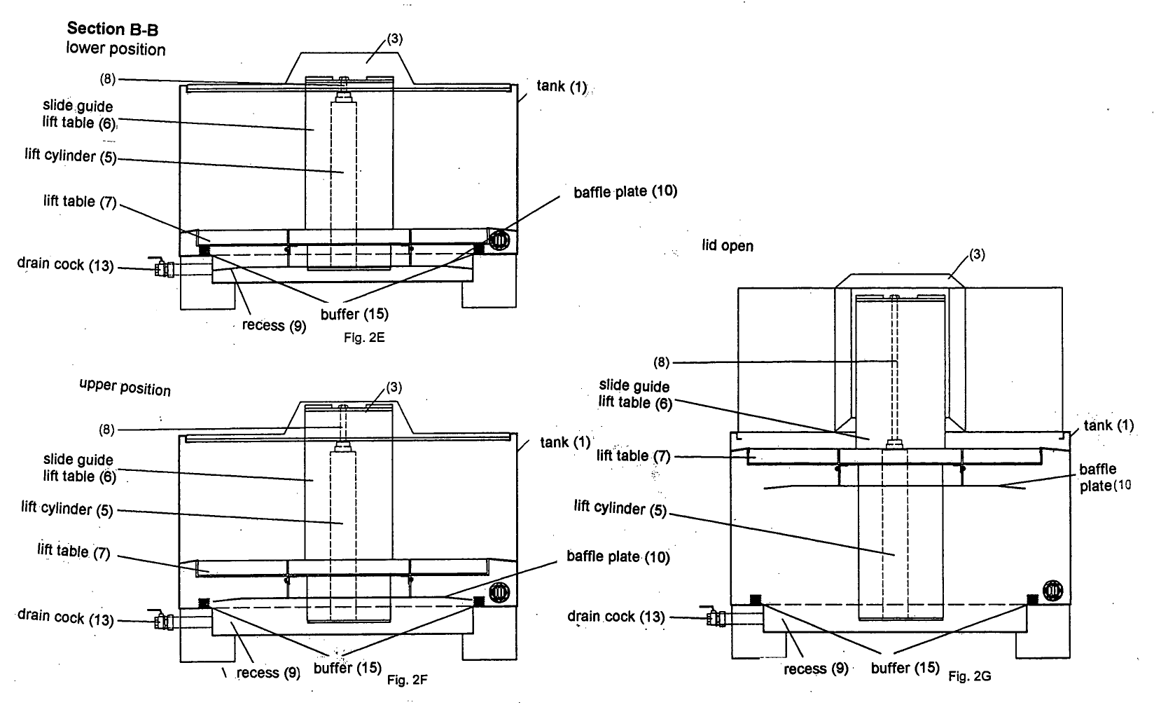

FIG. 2A shows a second embodiment of the lift/immersion system in a schematic top view;

FIGS. 2B to 2D show the lift immersion system in schematic side views in the lower position of the lift table, the upper position of the lift table during the treatment process and in the loading and unloading position of the lift table;

FIGS. 2E to 2G show corresponding schematic illustrations of the embodiment from the front;

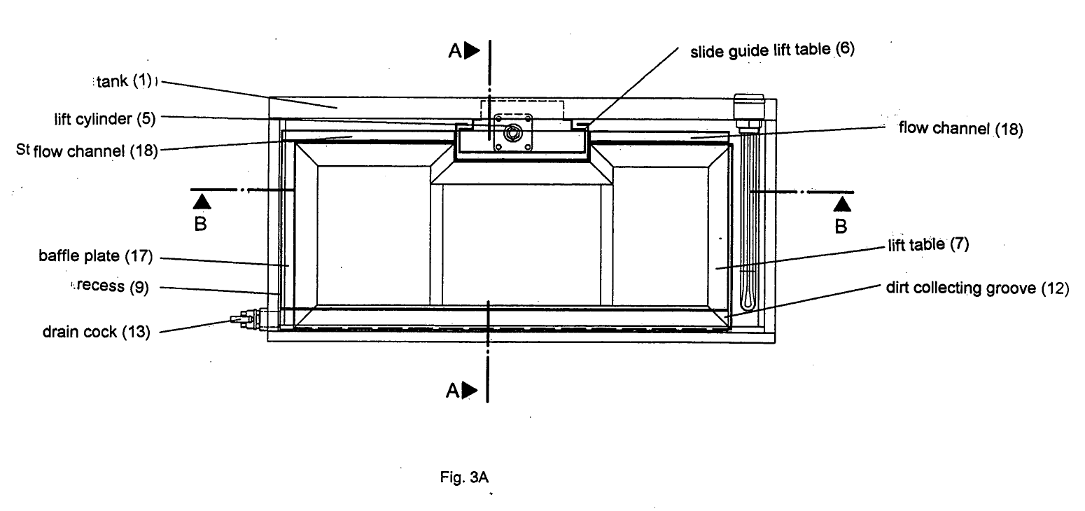

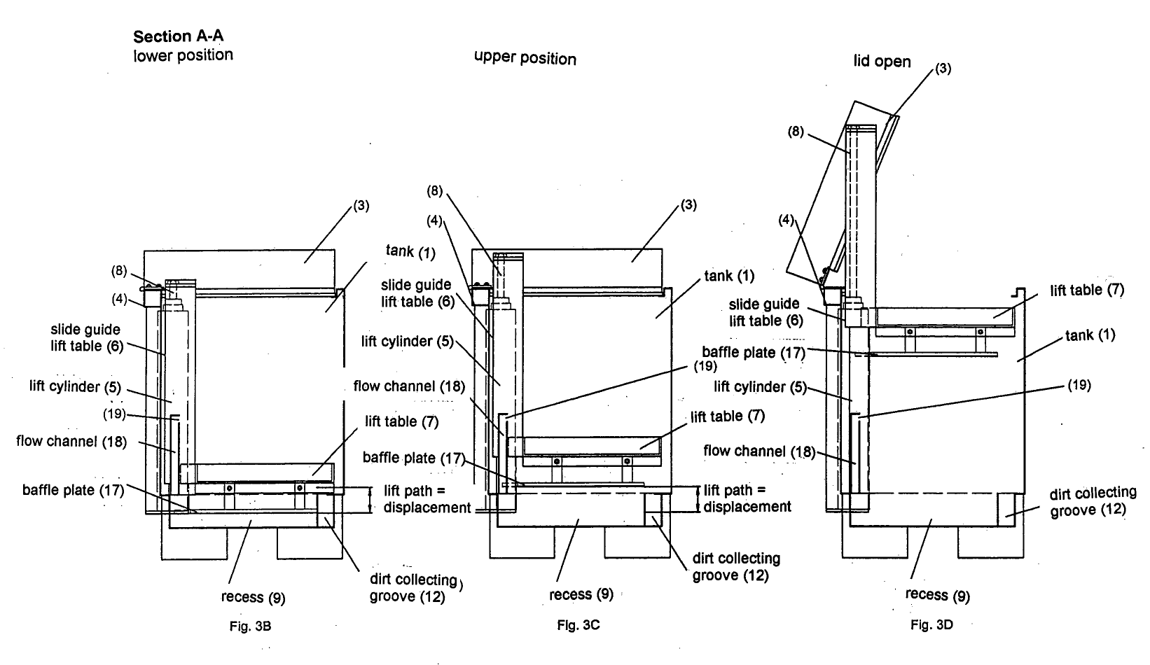

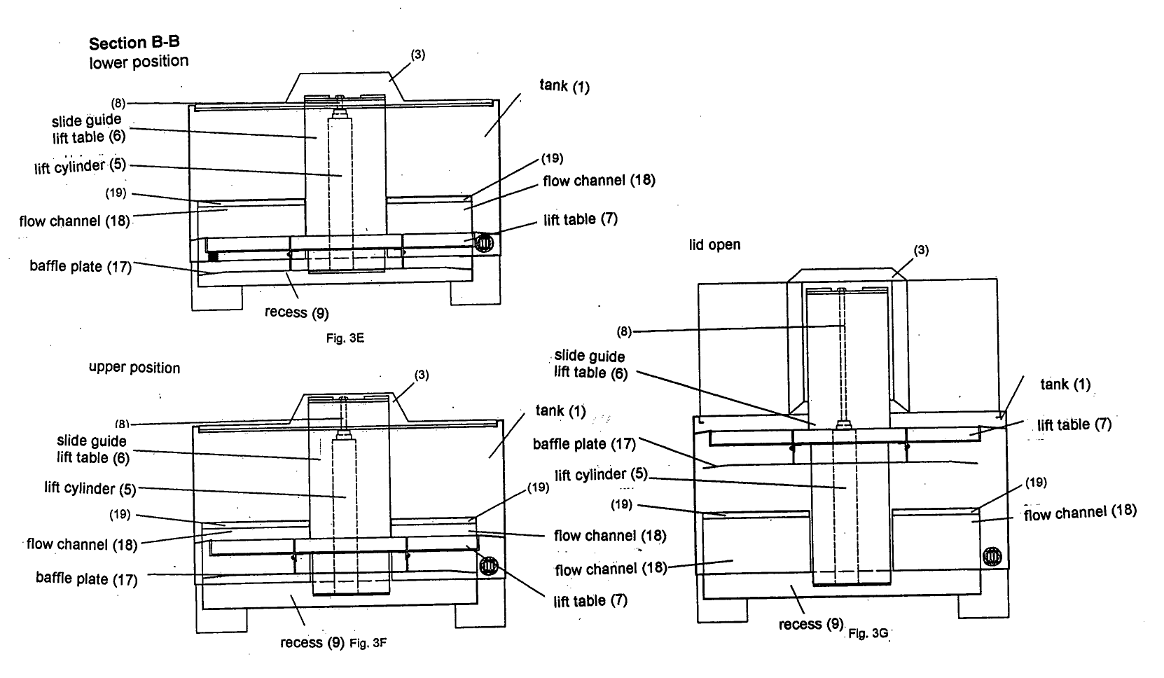

FIG. 3A shows a third embodiment of the lift/immersion system in a schematic top view;

FIGS. 3B to 3D show the lift/immersion system in schematic side views in the lower position of the lift table, the upper position of the lift table during the treatment process and in the loading and unloading position of the lift table;

FIGS. 3E to 3G show corresponding schematic illustrations of the embodiment from the front;

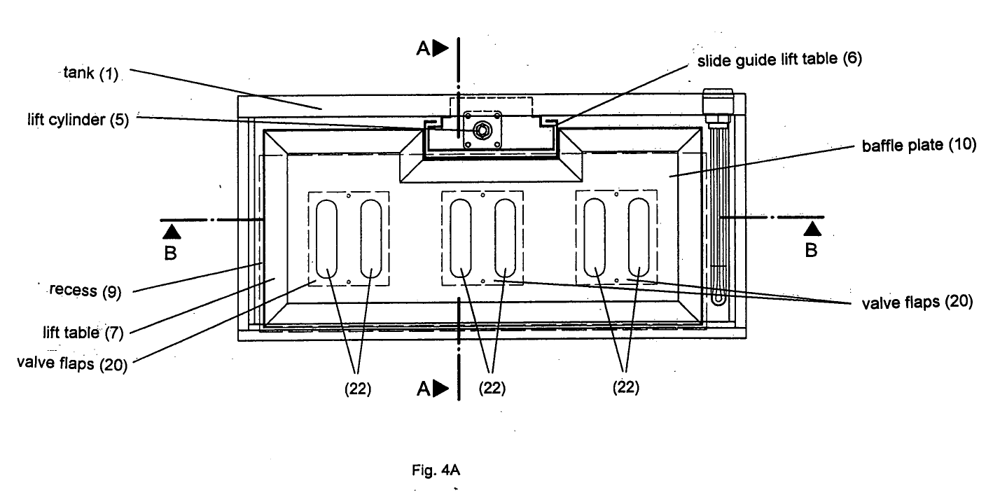

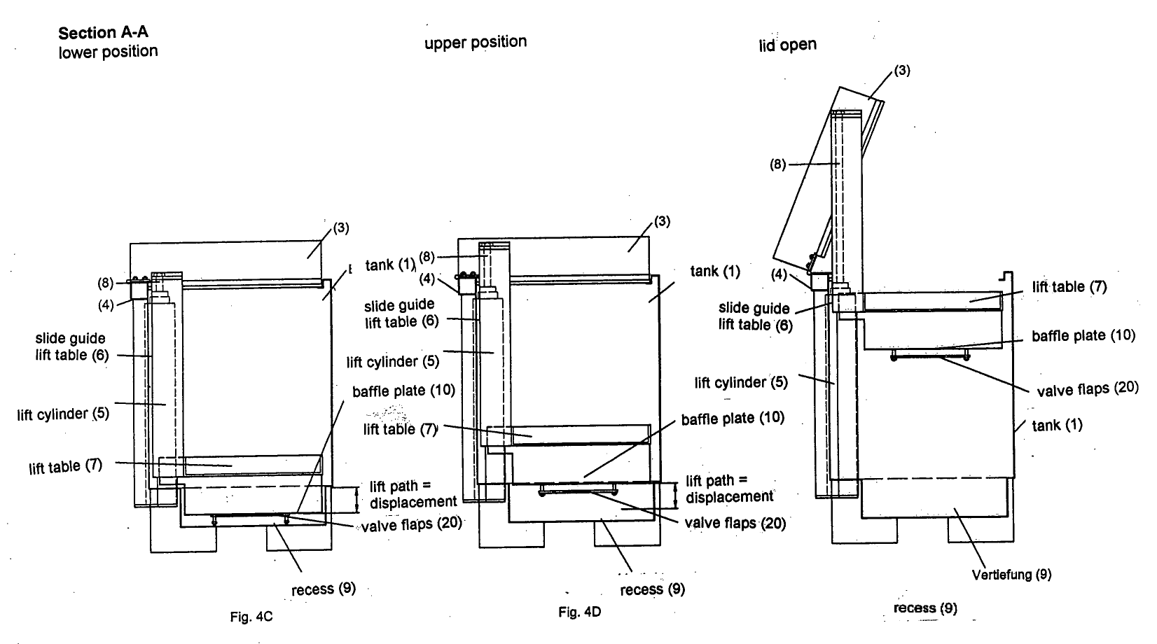

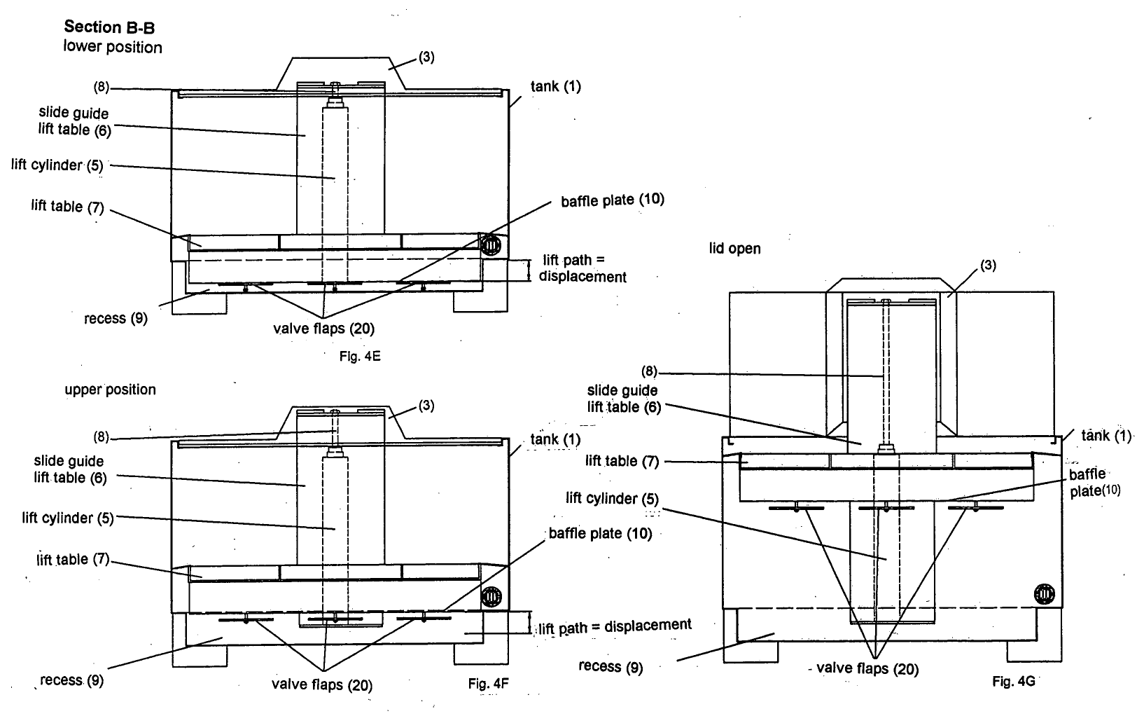

FIG. 4A shows a fourth embodiment of the lift/immersion system in a schematic top view;

FIGS. 4B to 4D show the lift/immersion system in schematic side views in the lower position of the lift table, the upper position of the lift table during the treatment process and in the loading and unloading position of the lift table;

FIGS. 4E to 4G shows corresponding schematic illustrations of the embodiment from the front.

FIGS. 1A to 1G show a first embodiment of the lift/immersion system according to the invention. A tank 1 which is standing on feet 2 is provided with a collapsible lid 3 which is hinged to the rear wall of the tank 1. In the center of the rear wall 4, a vertically oriented pneumatic lift cylinder 4 is mounted in the tank, the cylinder being surrounded by a slide guide 6 for a lift table 7. The piston rod 8 of the lift cylinder 5 is in drive communication with the slide guide 6 element connected to the lift table 7, so that the lift table 7 can be lifted and lowered by the pneumatic piston/cylinder assembly 5.

The lift table 7 includes a grid-like support surface for the articles to be treated.

The bottom of tank 1 has formed thereon a trough-like recess 9 into which a baffle plate 10 can enter with a slight lateral play, the baffle plate being attached by webs 11 under the lift table at some distance from said table. Next to the bottom recess 9 a dirt collecting groove 12 is formed which is provided with a drain cock 13 with which collected dirt can be discharged out of the housing 1.

In this embodiment the baffle plate 10 is provided with a multitude of small slits 14 evenly spaced apart in the longitudinal direction of the device. The purpose of said slits shall be described further below.

FIG. 1D shows the loading and unloading position of the lift table 7. In this position, the piston rod 8 of the pneumatic piston/cylinder assembly 5 is completely extended, the slide guide element attached to the lift table 7 lifting the lift table into the uppermost position within housing 1. The slide guide element with the piston rod 8 has here run onto the previously closed lid 3 and has pivoted the lid into the open position shown in FIG. 1D.

After for example articles to be cleaned have been placed on the lift table 7 or put into the grid-like basket thereof, the lift table is moved downwards, the lid moving due to gravity into the closed position. The tank accommodates a treatment bath which in the case of a cleaning process may be lye or, for instance, cleaner's solvent.

After the lid has been closed safely, the lift table 7 is first lowered into the upper position of the treatment process shown in FIGS. 1C and 1F, in which the baffle plate 10 is positioned at a small distance above the edge of the recess 9 on the bottom of the housing. As can be seen from the schematic illustration of FIG. 1F, the baffle plate is bent downwards on two opposite edges at a flat angle.

In the treatment process, e.g. in the cleaning process of the device, the lift table 7 is moved upwards and downwards in the immersion bath at a frequency of preferably 40 to 80 lifts/minute, most preferably 60 lifts/minute between the positions shown in FIGS. 1F/1C and 1B/1E, a lift distance of preferably 50 to 100 mm being covered each time. When the baffle plate in its downward travel dips with a slight lateral play into the recess 9, the treatment liquid is displaced through the slits 14 upwards, the liquid jets causing strong turbulences in the immersion bath that considerably intensify the treatment effect created by the upward and downward movement. The efficiency of the system can easily be doubled by the turbulences generated by the displaced liquid.

In the upper position of the treatment process, the baffle plate 10 is positioned at a distance above the edge of the recess 9, so that previously displaced liquid can again flow back under the baffle plate 10.

The second embodiment of the invention shown in FIGS. 2A to 2G differs from the first embodiment in that the dirt collecting groove 12 is arranged at the side of the baffle plate 10 that is oriented towards the lift cylinder 5. In this case, too, the dirt collecting groove is provided with a drain cock 13 leading out of the housing 1. Moreover, buffers 15 are provided outside the movement path of the baffle plate 10 on which the lift table 7 impinges in the lower position. Otherwise, the second embodiment of the invention is identical with the first embodiment.

The third embodiment of the invention shown in FIGS. 3A to 3G includes some essential changes. In this embodiment the baffle plate 17 is a closed plate without any passage opening for displaced liquid. The bottom recess 9 into which the baffle plate 17 enters during the treatment process communicates with a vertically upwardly extending flow channel 18 which extends beyond the upper position of the lift table 7 (in the treatment process). In the wall facing the lift table 7 the flow channel 18 has at least one, preferably several, exit slits, of which in the schematic illustrations of FIGS. 3B to 3G only one exit slit 19 arranged on the upper edge is shown. Further slits may be positioned thereunder, but this need not necessarily be the case.

As shown in FIGS. 3E to 3G, the flow channel 19 may also consist of two separate flow channels at both sides of the slide guide 6.

In this embodiment, during the downward movement of the lift table 7 and the baffle plate 17 attached thereto, liquid is displaced out of the recess 9 into the flow channel 18 in which the treatment liquid is pressed upwards and exits out of the slit 19 (and optionally further slits) towards the lift table 7. In this process the ejected water jets create strong turbulences in the immersion bath, the turbulences, in turn, considerably intensifying the treatment effect.

It goes without saying that it is within the scope of the present invention that in the third embodiment slits or holes may also be provided in the baffle plate, so that turbulences, starting from both the baffle plate and the flow channel, are generated in the immersion bath.

FIGS. 4A to 4G show a fourth embodiment similar to the third embodiment. Valve flaps 20 are provided that consist of planar plates displaceably attached to short pins 21 underneath the baffle plate 10. Large passage openings are provided in the baffle plate 10 in the area of the valve flaps 20, the passage openings being covered by the valve flaps 20.

During the downward movement of the baffle plate into recess 9, the counter-pressure of the liquid has the effect that the valve flaps 20 come to rest tightly on the bottom side of the baffle plate 10, whereby the passage openings 22 in the baffle plate are closed. Liquid can thereby be displaced upwards under high pressure out of the recess 9 either through slits of the baffle plate (as in the first two embodiments) and/or between the edges of the baffle plate and the walls of the recess and the housing, thereby forming flow channels.

When the lift table is moved upwards, the valve flaps will slide along the pins a small distance away from the baffle plate until they rest for example on heads of the pins, so that during the upward movement of the baffle plate treatment liquid can pass through the openings 22 under the baffle plate.

As has been stated above, the baffle plate forms flow channels with the walls of the recess and the housing.

The lift/immersion system comprises a device for discharging oils, greases and dirt particles deposited on the surface of the treatment bath. In this discharge device a jet system is provided in the tank 1 for generating a surface movement of the treatment liquid.

1. A lift/immersion system for treating, particularly cleaning, workpieces, comprising a housing into which a treatment liquid, particularly a cleaning liquid, can be filled which forms an immersion bath in the housing, further comprising a lift device and a lift table connected thereto and provided with passage openings, on which the workpieces can be placed, and which during the treatment process is movable upwards and downwards through the immersion bath, characterized in
that under the lift table a baffle plate is attached which during the treatment process is moved upwards and downwards in a section of the immersion bath with a small lateral play, so that treatment liquid is displaced during the downward movement and directed onto the workpieces with formation of turbulences in the immersion bath.

2. The lift/immersion system according to claim 1, characterized in
that the section is formed by a trough-like recess on the bottom of the housing.

3. The lift/immersion system according to claim 2, characterized in
that a surrounding gap remains between the circumferential walls of the recess and the edge of the baffle plate.

4. The lift/immersion system according to claim 1, characterized in
that the baffle plate comprises passage openings for the treatment liquid.

5. The lift/immersion system according to claim 4, characterized in
that the passage openings are small slits and/or round holes.

6. The lift/immersion system according to claim 2, characterized in
that the recess has connected thereto at least one upright flow channel which extends up to and beyond the upper position of the lift table and has at least one lateral exit opening from which treatment liquid displaced into the at least one flow channel is directed onto the workpieces while generating turbulences in the immersion bath.

7. The lift/immersion system according to claim 1, characterized in
that the lift device is formed by a single piston/cylinder assembly.

8. The lift/immersion system according to claim 7, characterized in
that a pneumatic piston/cylinder assembly is provided.

9. The lift/immersion system according to claim 1, characterized in
that the baffle plate is provided with valve flaps which during the downward movement automatically perform a closing action and which during the upward movement of the baffle plate automatically perform an opening action.

10. The lift/immersion system according to claim 1, further characterized by
a device for discharging oils, greases and dirt particles deposited on the surface of the treatment bath.

11. The lift/immersion system according to claim 10, characterized in
that a nozzle system is provided in the tank as the discharge device, the nozzle system generating a surface movement of the treatment liquid.
